(19) United States
(12) Patent Application Publication
(10) Pub. No.: US 2026/0202548 A1
(43) Pub. Date: Jul. 16, 2026

(54) RAYLEIGH DOPPLER LIDAR FOR MEASURING TEMPERATURE AND WIND

(71) Applicant: UNIVERSITY OF SCIENCE AND TECHNOLOGY OF CHINA, Hefei, Anhui (CN)

(72) Inventors: Xin FANG, Hefei, Anhui (CN); Tao LI, Hefei, Anhui (CN); Leilei SUN, Hefei, Anhui (CN)

(21) Appl. No.: 19/108,932

(22) PCT Filed: Nov. 9, 2023
(86) PCT No.: PCT/CN2023/130656

§ 371 Date: Mar. 5, 2025

(51) Int. Cl. G01S 17/95; G01S 7/481; G01S 7/484; G01S 7/4861; G01S 7/487; G01S 7/497

(52) U.S. Cl. CPC G01S 17/95; G01S 7/4814; G01S 7/4818; G01S 7/484; G01S 7/4861; G01S 7/4876; G01S 7/497

(57) ABSTRACT

A Rayleigh Doppler lidar for measuring temperature and wind is provided, including: a laser transmitter including: a seed laser generation device for generating a first seed laser and a second seed laser under control of a control voltage signal, the first seed laser including sub-seed laser sequences with three different frequencies in time sequence; a pulse laser for outputting a first pulse laser when the first seed laser is injected into the pulse laser; a laser transmission coupling unit for generating a transmitting laser transmitted to atmospheric environment and a second pulse laser according to the first pulse laser; a frequency calibration device for outputting the control voltage signal and a voltage level signal according to the second seed laser and the second pulse laser; and a laser receiver for simultaneously measuring wind speed and temperature in atmospheric environment according to a backscattered echo signal and the voltage level signal.

### CROSS REFERENCE TO RELATED APPLICATION(S)

This application is a Section 371 National Stage Application of International Application No. PCT/CN2023/130656, filed on Nov. 9, 2023, entitled “RAYLEIGH DOPPLER LIDAR FOR MEASURING TEMPERATURE AND WIND”, which is incorporated herein by reference in its entirety.

### TECHNICAL FIELD

The present disclosure relates to a field of lidar, and more specifically, to a Rayleigh Doppler lidar for measuring temperature and wind.

### BACKGROUND

Detection of near-space (20 km to 100 km) environment is of great significance to a change in the Earth's atmospheric environment, human aerospace activities, and a design and flight control of a spacecraft. In recent years, detection of a wind field, a density and a temperature of the near-space has been paid more and more attention by major countries. At present, a Rayleigh lidar is commonly used for detection of a temperature and a density in a stratosphere-mesosphere region (30 km to 70 km). However, the existing Rayleigh lidar requires a density reference point and a temperature reference point for inverting an atmospheric density and temperature. In a process of wind speed inversion, an inversion error of the temperature may cause a measurement error of the wind speed.

### SUMMARY

In view of this, embodiments of the present disclosure provide a Rayleigh Doppler lidar for measuring temperature and wind, including:
a laser transmitter, including:
a seed laser generation device configured to generate a first seed laser and a second seed laser under a control of a control voltage signal, where each of the first seed laser and the second seed laser includes sub-seed laser sequences with three different frequencies in time sequence;
a pulse laser configured to output a first pulse laser in a case that the first seed laser is injected into the pulse laser, where the first pulse laser includes sub-pulse laser sequences with three different frequencies; and
a laser transmission coupling unit configured to generate a transmitting laser transmitted to an atmospheric environment and a second pulse laser according to the first pulse laser, where the transmitting laser interacts with a molecule in the atmospheric environment to generate a backscattered echo signal;
a frequency calibration device configured to output the control voltage signal and a voltage level signal according to the second seed laser and the second pulse laser, where the control voltage signal is configured to lock a laser frequency of the seed laser; and
a laser receiver configured to receive the backscattered echo signal and simultaneously measure a wind speed and a temperature in the atmospheric environment according to the backscattered echo signal and the voltage level signal.

According to embodiments of the present disclosure, the seed laser generation device includes:
a seed laser configured to output a continuous laser with a narrow band linewidth under the control of the control voltage signal;
an optical fiber beam splitter configured to split the continuous laser into a first laser and a second laser, where a power of the first laser is greater than a power of the second laser, and the second laser indicates the second seed laser; and
an optical fiber acousto-optic frequency shifter configured to generate the first seed laser according to the first laser.

According to embodiments of the present disclosure, the laser transmission coupling unit includes:
a beam expander configured to adjust a laser spot and a divergence angle of the first pulse laser to obtain a third laser; and
a first optical splitter configured to split the third laser into the transmitting laser and the second pulse laser.

According to embodiments of the present disclosure, the laser transmission coupling unit further includes:
a transmitting antenna configured to transmit the transmitting laser to the atmospheric environment.

According to embodiments of the present disclosure, the frequency calibration device includes:
a harmonic generator configured to perform a frequency doubling processing on the second seed laser to obtain a seed frequency-doubled laser;
a frequency calibrator configured to generate a first electrical signal and a second electrical signal according to the second pulse laser and the seed frequency-doubled laser;
a feedback circuit configured to generate the control voltage signal according to the first electrical signal; and
an integrator configured to generate the voltage level signal according to the second electrical signal.

According to embodiments of the present disclosure, the frequency calibrator includes:
a first iodine cell configured to:
   process the seed frequency-doubled laser using an absorption spectrum of an iodine molecule, so as to obtain a processed seed frequency-doubled laser; and
   process the second pulse laser using the absorption spectrum of the iodine molecule, so as to obtain a processed second pulse laser;
a first photodiode configured to perform an amplification and a photoelectric conversion processing on the processed seed frequency-doubled laser to obtain the first electrical signal; and
a second photodiode configured to perform a photoelectric conversion processing on the processed second pulse laser to obtain the second electrical signal;
where the voltage level signal is configured to lock a frequency of the seed laser and monitor a frequency difference between the first pulse laser and the first seed laser, so as to correct a detection error.

According to embodiments of the present disclosure, the laser receiver includes:
a telescope configured to receive the backscattered echo signal returned from the atmospheric environment;
a signal processing device configured to generate a quasi-parallel beam according to the backscattered echo signal;
an iodine molecule processing device configured to generate a reference signal and a target signal according to the quasi-parallel beam; and
a computing processor configured to simultaneously measure the wind speed and the temperature in the atmospheric environment according to the reference signal, the target signal, and the voltage level signal.

According to embodiments of the present disclosure, the signal processing device includes:
a chopper configured to suppress a near-field strong echo signal in the backscattered echo signal under a driving of a motor to obtain a synchronous main signal; and
a collimation lens configured to collimate the synchronous main signal to the quasi-parallel beam.

According to embodiments of the present disclosure, the signal processing device further includes:
a filter configured to perform a filtering processing on a background optical signal in the quasi-parallel beam to obtain a filtered quasi-parallel beam, so as to process the filtered quasi-parallel beam by the iodine molecule processing device.

According to embodiments of the present disclosure, the iodine molecule processing device includes:
a second optical splitter configured to split the quasi-parallel beam into a first optical signal and a second optical signal;
a first photomultiplier tube configured to perform a photoelectric conversion processing on the first optical signal to obtain a first electrical pulse signal, where the first electrical pulse signal indicates the reference signal;
a second iodine cell configured to perform an absorption processing on the second optical signal to obtain a target echo signal; and
a second photomultiplier tube configured to perform a photoelectric conversion processing on the target echo signal to obtain the target signal.

### BRIEF DESCRIPTION OF THE DRAWINGS

FIG. 1 shows a frame diagram of a Rayleigh Doppler lidar for measuring temperature and wind according to embodiments of the present disclosure.

FIG. 2 shows a frame diagram of a seed laser generation device according to embodiments of the present disclosure.

FIG. 3 shows a frame diagram of a laser transmission coupling unit according to embodiments of the present disclosure.

FIG. 4 shows a frame diagram of a frequency calibration device according to embodiments of the present disclosure.

FIG. 5 shows a frame diagram of a frequency calibrator according to embodiments of the present disclosure.

FIG. 6 shows a frame diagram of a laser receiver according to embodiments of the present disclosure.

FIG. 7 shows a frame diagram of a signal processing device according to embodiments of the present disclosure.

FIG. 8 shows a frame diagram of an iodine molecule processing device according to embodiments of the present disclosure.

FIG. 9 shows a structural flowchart of a Rayleigh Doppler lidar for measuring temperature and wind according to embodiments of the present disclosure.

### DETAILED DESCRIPTION OF EMBODIMENTS

Embodiments of the present disclosure will be described below with reference to the accompanying drawings. However, it should be understood that these descriptions are merely exemplary and are not intended to limit the scope of the present disclosure. In the following detailed descriptions, for convenience of explanation, many specific details are set forth to provide comprehensive understanding of embodiments of the present disclosure. However, it is apparent that one or more embodiments may also be implemented without these specific details. In addition, in the following descriptions, descriptions of well-known structures and technologies are omitted to avoid unnecessarily obscuring the concept of the present disclosure.

Terms used herein are only intended to describe specific embodiments, rather than intended to limit the present disclosure. Terms “including”, “containing”, etc. used herein indicate the presence of the features, steps, operations and/or components, but do not exclude the presence or addition of one or more other features, steps, operations or components.

All terms (including technical and scientific terms) used herein have the meanings generally understood by those skilled in the art, unless otherwise defined. It should be noted that the terms used herein shall be interpreted as having the meaning consistent with the context of the present description, and should not be interpreted in an idealized or overly rigid manner.

In a case that an expression similar to “at least one selected from A, B or C” is used, the expression should generally be interpreted according to the meaning of the expression generally understood by those of ordinary skill in the art (for example, “a system having at least one selected from A, B or C” should include, but is not limited to, a system having A alone, a system having B alone, a system having C alone, a system having A and B, a system having A and C, a system having B and C, and/or a system having A, B and C, etc.).

A Rayleigh lidar is commonly used for detecting a temperature and a density in a stratosphere-mesosphere region (30 km to 70 km). An existing Rayleigh lidar requires a density reference point and a temperature reference point to invert an atmospheric density and temperature. Deviations of a density reference and a temperature reference may cause an error to a calculation of the temperature, and an absolute measurement of the temperature may not be achieved. The existing Rayleigh Doppler lidar transmits only a single-frequency laser. A receiver discriminates Doppler frequency shift information of a Rayleigh echo signal caused by an atmospheric wind speed by an interferometer etalon or an iodine molecular absorption cell discriminator. A single-frequency echo signal contains information of temperature and wind speed simultaneously. In a process of inverting the wind speed, it is required to calculate the temperature through a static equilibrium equation and an ideal gas state equation, and then calculate the wind speed. Therefore, an inversion error of the temperature may cause a measurement error of the wind speed.

In view of this, embodiments of the present disclosure provide a Rayleigh Doppler lidar for measuring temperature and wind, including: a laser transmitter, including: a seed laser generation device used to generate a first seed laser and a second seed laser under a control of a control voltage signal, where each of the first seed laser and the second seed laser includes sub-seed laser sequences with three different frequencies in time sequence; a pulse laser used to output a first pulse laser in a case that the first seed laser is injected into the pulse laser, where the first pulse laser includes sub-pulse laser sequences with three different frequencies; and a laser transmission coupling unit used to generate a transmitting laser transmitted to an atmospheric environment and a second pulse laser according to the first pulse laser, where the transmitting laser interacts with a molecule in the atmospheric environment to generate a backscattered echo signal; a frequency calibration device used to output the control voltage signal and a voltage level signal according to the second seed laser and the second pulse laser, where the control voltage signal is used to lock a laser frequency of the seed laser; and a laser receiver used to simultaneously measure a wind speed and a temperature in the atmospheric environment according to the backscattered echo signal and the voltage level signal.

According to embodiments of the present disclosure, the seed laser generation device generates the first seed laser and the second seed laser each including sub-seed laser sequences with three different frequencies in time sequence, the pulse laser generates the first pulse laser including sub-pulse laser sequences with three different frequencies in a case that the first seed laser is injected in a time-sharing manner, and the first pulse laser is input to the laser transmission coupling unit to generate the transmitting laser transmitted to the atmospheric environment and the second pulse laser, and in this case, the frequency calibration device outputs the control voltage signal and the voltage level signal based on the second seed laser and the second pulse laser, so as to control the seed laser generation device, so that the laser receiver receives the backscattered echo signal and the voltage level signal from the atmospheric environment while measuring the wind speed and the temperature in the atmospheric environment. Since the Rayleigh Doppler lidar for measuring temperature and wind of the present disclosure no longer depends on a density reference point and a temperature reference point, instead uses the first seed laser including sub-seed laser sequences with three different frequencies in time sequence as a system laser source to achieve an absolute measurement of the temperature and the wind speed, it may avoid a temperature measurement error caused by depending on the temperature reference point and the density reference point and a single-frequency laser wind measurement error caused by a temperature error, thereby greatly improving an accuracy and a sensitivity of the Rayleigh Doppler lidar for measuring temperature and wind when measuring the temperature and the wind speed.

By transmitting lasers of 532 nm and near 532 nm with a plurality of frequencies in time-sharing sequence and correspondingly receiving echo signal intensities respectively, Doppler broadening and frequency shift information caused by the wind speed is directly converted into signal intensities with a plurality of frequencies, and the temperature and information may be inverted according to the echo signal intensities. Since the present disclosure may achieve the absolute measurement of the temperature in the stratosphere-mesosphere region (30 km to 70 km) technically without depending on the density reference point and the temperature reference point; a three-frequency laser is used as the system laser source, while achieving the absolute measurement of the temperature, and an influence of the temperature on a spectral line is simultaneously considered in a process of calculating the wind speed, which may greatly improve the accuracy and sensitivity of the Rayleigh Doppler lidar for measuring the wind and the temperature. Therefore, it is possible to solve the temperature measurement error caused by the temperature reference point and the density reference point, and the single-frequency laser wind measurement error caused by the temperature error.

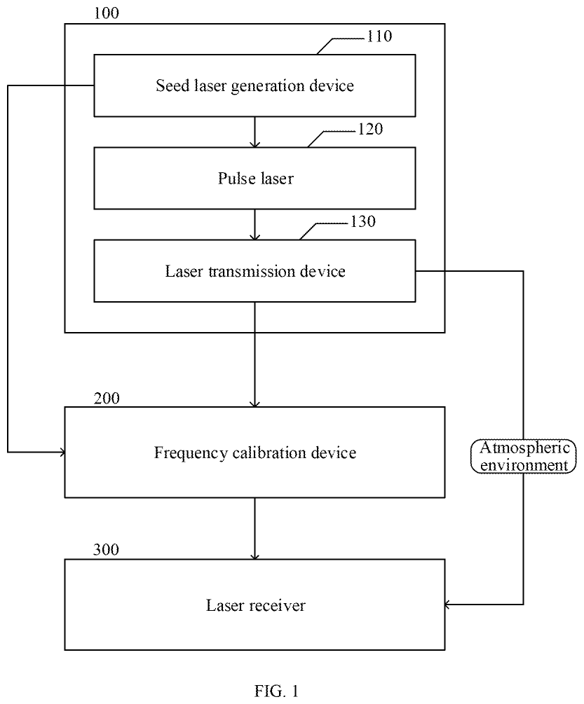

FIG. 1 shows a frame diagram of a Rayleigh Doppler lidar for measuring temperature and wind according to embodiments of the present disclosure.

As shown in FIG. 1, the Rayleigh Doppler lidar for measuring temperature and wind includes:
a laser transmitter 100, including: a seed laser generation device 110 used to generate a first seed laser and a second seed laser under a control of a control voltage signal, where each of the first seed laser and the second seed laser includes sub-seed laser sequences with three different frequencies in time sequence; a pulse laser 120 used to output a first pulse laser in a case that the first seed laser is injected into the pulse laser 120, where the first pulse laser includes sub-pulse laser sequences with three different frequencies; and a laser transmission coupling unit 130 used to generate a transmitting laser transmitted to an atmospheric environment and a second pulse laser according to the first pulse laser, where the transmitting laser interacts with a molecule in the atmospheric environment to generate a backscattered echo signal;
a frequency calibration device 200 used to output the control voltage signal and a voltage level signal according to the second seed laser and the second pulse laser, where the control voltage signal is used to lock a laser frequency of the seed laser; and
a laser receiver 300 used to receive the backscattered echo signal and simultaneously measure a wind speed and a temperature in the atmospheric environment according to the backscattered echo signal and the voltage level signal.

According to embodiments of the present disclosure, the pulse laser 120 may be a flash-lamp pump or a diode pump laser. A type of the pulse laser 120 in the present disclosure will not be limited, and may be selected by those skilled in the art as desired in practice. In an embodiment, the pulse laser 120 outputs a first pulse laser of 1064.4 nm with a fundamental frequency, and outputs a first pulse laser of 532.2 nm after frequency doubling. In a case that the first seed laser including sub-seed laser sequences with three different frequencies in time sequence output by the seed laser generation device 110 is injected in a time-sharing manner, a first pulse laser of 532.2 nm with a narrow linewidth is output, where the first pulse laser includes sub-pulse laser sequences with three different frequencies of v₅₃₂, v₅₃₂+2f₁ and v₅₃₂−2f₂.

According to embodiments of the present disclosure, the Rayleigh Doppler lidar for measuring temperature and wind of the present disclosure may technically achieve the absolute measurement of the temperature and the wind speed in the stratosphere-mesosphere region (30 km to 70 km) without depending on the density reference point and the temperature reference point, and the influence of the temperature on the spectral line is simultaneously considered in the process of calculating the wind speed and the temperature.

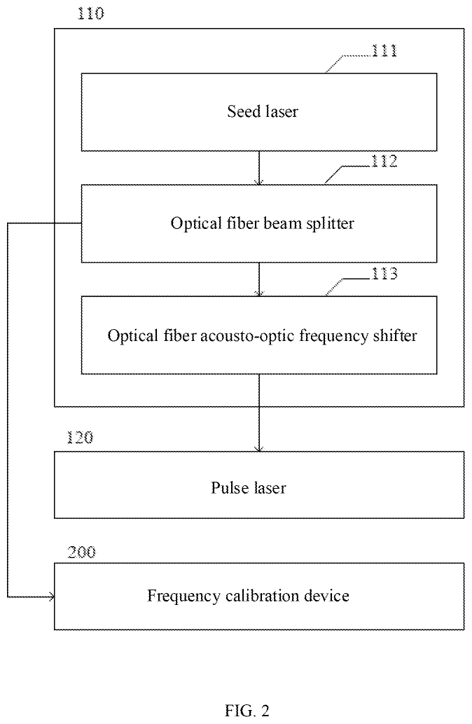

FIG. 2 shows a frame diagram of a seed laser generation device according to embodiments of the present disclosure.

According to embodiments of the present disclosure, the seed laser generation device 100 includes: a seed laser 111 used to output a continuous laser with a narrow band linewidth under the control of the control voltage signal; an optical fiber beam splitter 112 used to split the continuous laser into a first laser and a second laser, where a power of the first laser is greater than a power of the second laser, and the second laser indicates the second seed laser; and an optical fiber acousto-optic frequency shifter 113 used to generate the first seed laser with three different frequencies based on the first laser.

According to embodiments of the present disclosure, the seed laser Ill is a semiconductor laser used to output a continuous laser of 1064 nm with a narrow band linewidth. An output interface may be an optical fiber port.

According to embodiments of the present disclosure, the optical fiber beam splitter 112 is used to split the laser of 1064 nm output by the seed laser into two paths of outputs. The first laser outputs at least 20 mW power for optical fiber acousto-optic modulation. The second laser outputs at least 10 mW power for laser frequency stabilization after frequency doubling. The second laser indicates the second seed laser.

According to embodiments of the present disclosure, the optical fiber acousto-optic frequency shifter 113 is internally integrated with a switch. The first laser is split into three paths by a one-to-three switch, in which one path does not change a frequency of the seed laser and outputs a sub-seed laser with an output frequency of v₁₀₆₄, one path shifts the frequency and outputs a sub-seed laser with a laser frequency of v₁₀₆₄+f₁, and the last path shifts the frequency and outputs a sub-seed laser with an output frequency of v₁₀₆₄−f₂. A switching time of the switch is set to switch once every second according to the timing control of the lidar system. The sub-seed laser sequences with different frequencies are synthesized into a path of laser output by a three-in-one switch, serving as a seed injection laser of the pulse laser 120, that is, the first seed laser including sub-seed laser sequences with three different frequencies in time sequence.

According to embodiments of the present disclosure, the seed laser 111 outputs a continuous laser with a narrow band linewidth under the control of the control voltage signal, the optical fiber beam splitter 112 splits the continuous laser into the first laser and the second laser, and the second laser indicates the second seed laser input to the frequency calibration device 200. The first laser passes through the optical fiber acousto-optic frequency shifter 113 to generate the first seed laser, and the output first seed laser is input to the pulse laser 120.

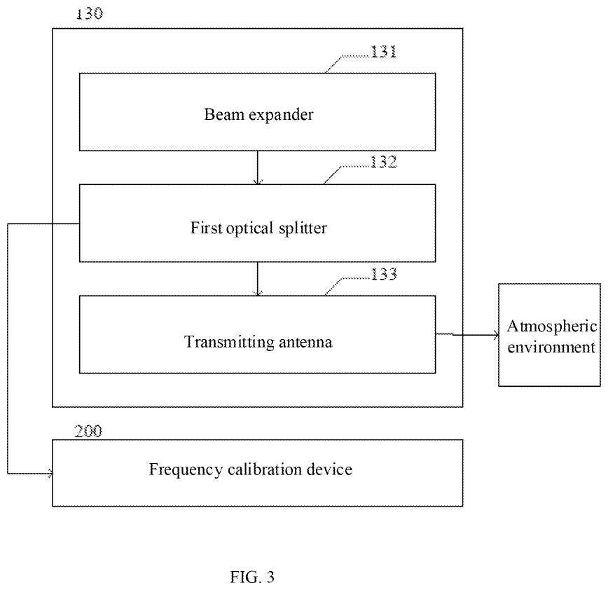

FIG. 3 shows a frame diagram of a laser transmission coupling unit according to embodiments of the present disclosure.

According to embodiments of the present disclosure, the laser transmission coupling unit 130 includes: a beam expander 131 used to adjust a laser spot and a divergence angle of the first pulse laser to obtain a third laser; and a first optical splitter 132 used to split the third laser into the transmitting laser and the second pulse laser.

According to embodiments of the present disclosure, the beam expander 131 adopts a dual-lens Galilean structure, in which an ocular lens is a concave lens and an output lens is a convex lens. The beam expander 131 is used to improve the divergence angle of the first pulse laser of 532.2 nm of the pulse laser 120 and reduce a beam power density, such as enlarging a size of a laser spot of the laser and improving the divergence angle of the beam to a receiving field of view of a telescope 310. A type of the beam expander 131 of the present disclosure will not be limited, and may be selected by those skilled in the art as desired in practice.

According to embodiments of the present disclosure, a surface of the first optical splitter 132 is plated with an optical splitting film, and an optical splitting ratio may be 99.5%/0.5%. The first optical splitter 132 splits the third laser output by the beam expander 131 into two paths, that is, the transmitting laser and the second pulse laser. The transmitting laser is transmitted to the atmospheric environment, and interacts with a molecule in the atmosphere to generate the backscattered echo signal. The second pulse laser, as an input of the frequency calibration device 200, is used to monitor a frequency of the first pulse laser, and detect a frequency difference between the frequency of the first pulse laser and a frequency of the first seed laser. A type of the first optical splitter 132 of the present disclosure will not be limited, and may be selected by those skilled in the art as desired in practice.

According to embodiments of the present disclosure, the laser transmission coupling unit further includes: a transmitting antenna 133 used to transmit the transmitting laser to the atmospheric environment.

According to embodiments of the present disclosure, the transmitting antenna 133 is formed by an optical lens frame and a 532 nm reflective lens, and the transmitting laser output by the first optical splitter 132 is transmitted to the atmospheric environment.

According to embodiments of the present disclosure, the beam expander 131 adjusts the first pulse laser to obtain the third laser. The first optical splitter 132 splits the third laser into the transmitting laser and the second pulse laser. The transmitting laser is transmitted to the atmospheric environment by the transmitting antenna 133, and the second pulse laser is input to the frequency calibration device 200.

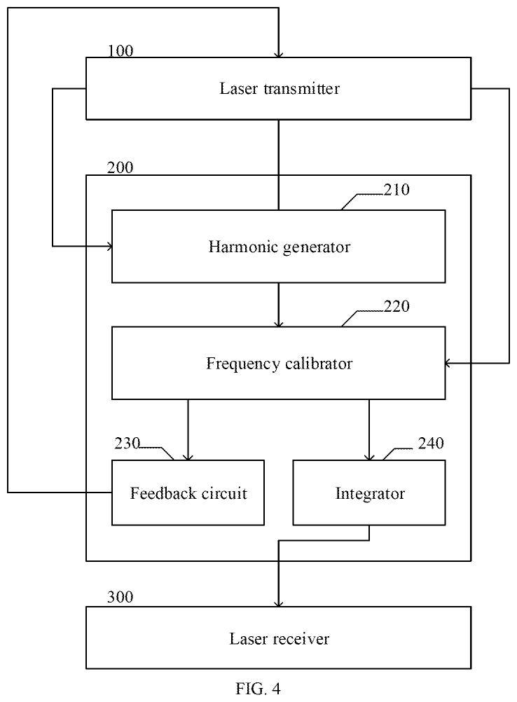

FIG. 4 shows a frame diagram of a frequency calibration device according to embodiments of the present disclosure.

According to embodiments of the present disclosure, the frequency calibration device 200 includes: a harmonic generator 210 used to perform a frequency doubling processing on the second seed laser to obtain a seed frequency-doubled laser; a frequency calibrator 220 used to generate a first electrical signal and a second electrical signal according to the second pulse laser and the seed frequency-doubled laser; a feedback circuit 230 used to generate a control voltage signal according to the first electrical signal; and an integrator 240 used to generate a voltage level signal according to the second electrical signal.

According to embodiments of the present disclosure, the harmonic generator 210 is made of a periodic lithium niobate PPLN crystal, and is used to perform the frequency doubling processing on the second seed laser of the optical fiber beam splitter 112 to obtain the seed frequency-doubled laser. For example, a continuous second seed laser of 1064.4 nm output by one path of the optical fiber beam splitter 112 is frequency-doubled to a continuous seed frequency-doubled laser of 532.2 nm.

According to embodiments of the present disclosure, the frequency calibrator 220 has two paths of inputs. One path inputs the seed frequency-doubled laser and locks a frequency of the seed laser by an absorption spectrum of an iodine molecule, so as to generate the first electrical signal. The other path inputs the second pulse laser and monitors a frequency difference between the first pulse laser and a continuous seed laser to correct a detection error, so as to generate the second electrical signal.

According to embodiments of the present disclosure, the feedback circuit 230 calculates the control voltage signal by an internal proportional-integral-derivative (PID) controller according to the first electrical signal output by the frequency calibrator 220, and outputs the control voltage signal to a wavelength adjustment module of the seed laser 111, thereby tracking and locking the laser frequency of the seed.

According to embodiments of the present disclosure, the integrator 240 is provided with a trigger module, a delay adjustment module, a gate width adjustment module, and a high-speed acquisition and integration circuit inside. The trigger module is used to synchronize a laser pulse and an internal acquisition and integration circuit. The delay adjustment module is used to adjust the synchronization of the laser pulse and the internal acquisition and integration circuit, so as to ensure that a complete pulse signal may be acquired and integrated. A gate width is adjusted to cover a spectral signal of a first pulse laser of 532.2 nm output by the frequency calibrator 220 after an absorption of the iodine molecule, and a gate width is set to cover an entire pulse width. The internal acquisition and integration circuit is used to generate a voltage level signal according to the output second electrical signal, and acquire it in a digital form and store it in an internal register.

According to embodiments of the present disclosure, the harmonic generator 210 performs a frequency doubling processing on the second seed laser output by the laser transmitter 100 to obtain a seed frequency-doubled laser, and a second electrical signal is generated by the frequency calibrator 220. The frequency calibrator 220 generates a first electrical signal according to the second pulse laser output by the laser transmitter 100. The feedback circuit 230 generates the control voltage signal according to the first electrical signal and inputs the control voltage signal back to the laser transmitter 100. The integrator 240 generates the voltage level signal according to the second electrical signal, and inputs the voltage level signal to the laser receiver 300.

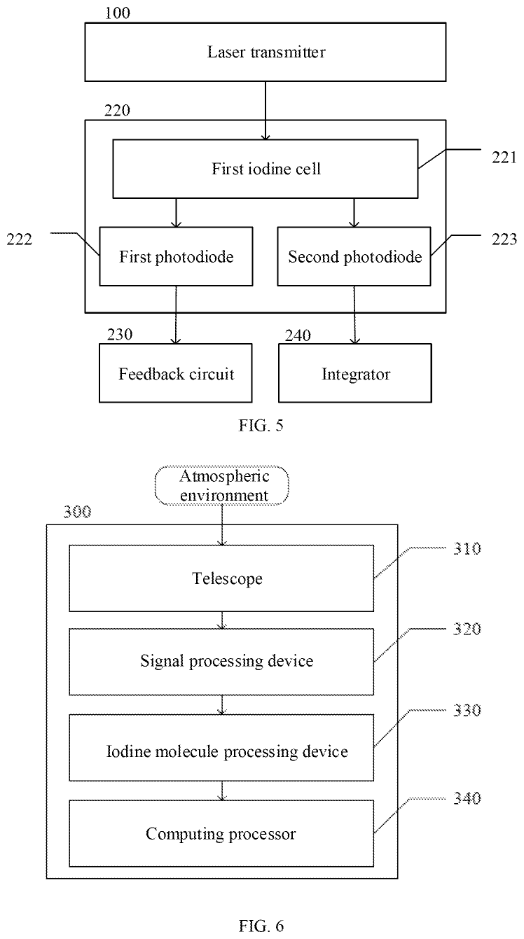

FIG. 5 shows a frame diagram of a frequency calibrator according to embodiments of the present disclosure.

According to embodiments of the present disclosure, the frequency calibrator 220 includes: a first iodine cell 221 used to: process the seed frequency-doubled laser using an absorption spectrum of an iodine molecule, so as to obtain a processed seed frequency-doubled laser; and process the second pulse laser using the absorption spectrum of the iodine molecule, so as to obtain a processed second pulse laser; a first photodiode 222 used to perform an amplification and a photoelectric conversion processing on the processed seed frequency-doubled laser to obtain the first electrical signal; and a second photodiode 223 used to perform a photoelectric conversion processing on the processed second pulse laser to obtain the second electrical signal; where the voltage level signal is used to monitor a frequency difference between the first pulse laser and the first seed laser to correct a detection error.

According to embodiments of the present disclosure, the first photodiode 222 is a photodiode with an amplification function. The second photodiode 223 is a general photodiode.

FIG. 6 shows a frame diagram of a laser receiver according to embodiments of the present disclosure.

According to embodiments of the present disclosure, the laser receiver 300 includes: a telescope 310 used to receive the backscattered echo signal returned from the atmospheric environment; a signal processing device 320 used to generate a quasi-parallel beam according to the backscattered echo signal; an iodine molecule processing device 330 used to generate a reference signal and a target signal according to the quasi-parallel beam; and a computing processor 340 used to simultaneously measure the wind speed and the temperature in the atmospheric environment according to the reference signal, the target signal, and the voltage level signal.

According to embodiments of the present disclosure, the telescope 310 is used to receive a backscattered echo signal of an atmospheric molecule with a Doppler frequency shift signal caused by the wind speed after a laser of 532.2 nm with three frequencies of (v₅₃₂, v₅₃₂+2f₁ and V₅₃₂−2f₂) interacts with the atmosphere.

The telescope 310 may receive an echo signal of the atmospheric molecule by a commonly used Newton telescope or Cassegrain telescope. A type of telescope of the present disclosure will not be limited, and may be selected by those skilled in the art as desired in practice. The direction to which the telescope points may be set to be a suitable direction according to actual scientific detection requirements. For example, in a case that a zonal wind requires to be detected, the telescope may point to an eastern direction or a west direction, and a zenith tilt angle is generally set between 15° and 30°; in a case that a meridional wind requires to be detected, the telescope may point to an eastern direction or a west direction, and a zenith tilt angle is generally set between 15° and 30°; in a case that a vertical wind requires to be detected, the telescope may point to the zenith. A lens of the telescope requires to be plated with a high reflective film for a wavelength of 532.2 nm, so as to ensure the receiving efficiency of the echo signal.

According to embodiments of the present disclosure, the computing processor 340 includes a photon counting card and various commonly-used interfaces, completing a signal acquisition and a cooperative control of components functions of the Rayleigh Doppler lidar for measuring temperature and wind, and is used to acquire and display the backscattered echo signal and monitor the frequency change of the transmitting laser.

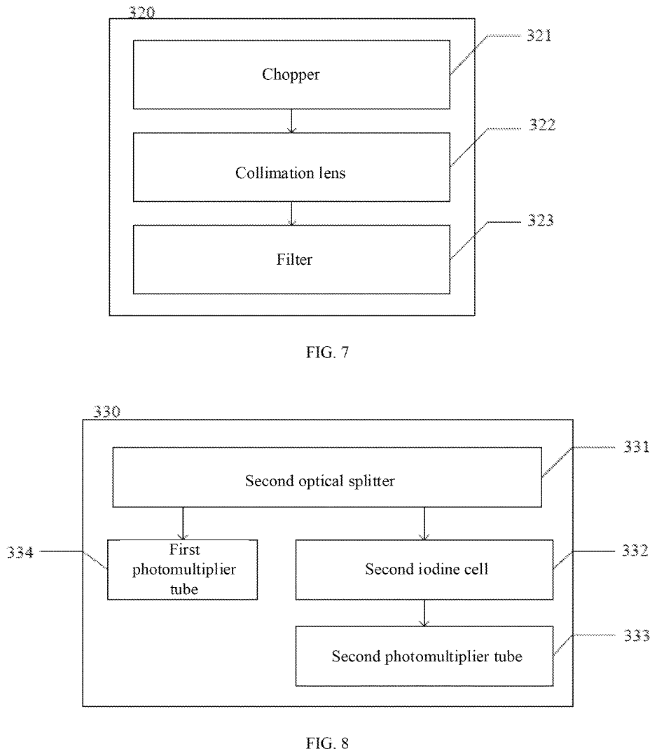

FIG. 7 shows a frame diagram of a signal processing device according to embodiments of the present disclosure.

According to embodiments of the present disclosure, the signal processing device 320 includes: a chopper 321 used to suppress a near-field strong echo signal in the backscattered echo signal under a driving of a motor to obtain a synchronous main signal; and a collimation lens 322 used to collimate the synchronous main signal to a quasi-parallel beam.

According to embodiments of the present disclosure, the chopper is used to suppress a low-altitude strong echo signal to ensure that a subsequent detection portion operates in a linear range. A disc of the chopper is provided with a notch thereon. The disc is driven by a high-speed motor to rotate at a high speed set by the lidar system, so as to achieve a suppression of the near-field strong echo signal for the lidar system. A trigger signal generation transmitting and receiving module is provided on two sides of the chopper and is used to output a synchronous main signal required by the lidar system.

According to embodiments of the present disclosure, the collimation lens is used to collimate an optical signal of the echo signal received by the telescope after passing through a transmission optical fiber to the quasi-parallel beam.

According to embodiments of the present disclosure, the signal processing device further includes: a filter 323 used to perform a filtering processing on a background optical signal in the quasi-parallel beam to obtain a filtered quasi-parallel beam, so as to process the filtered quasi-parallel beam by the iodine molecule processing device 330.

According to embodiments of the present disclosure, the filter 323 may preliminarily filter out a background noise signal in the quasi-parallel beam, so as to preliminarily suppress a sky background optical signal. The filtered quasi-parallel beam may be obtained by the useful echo signal of 532.2 nm through the filter 323.

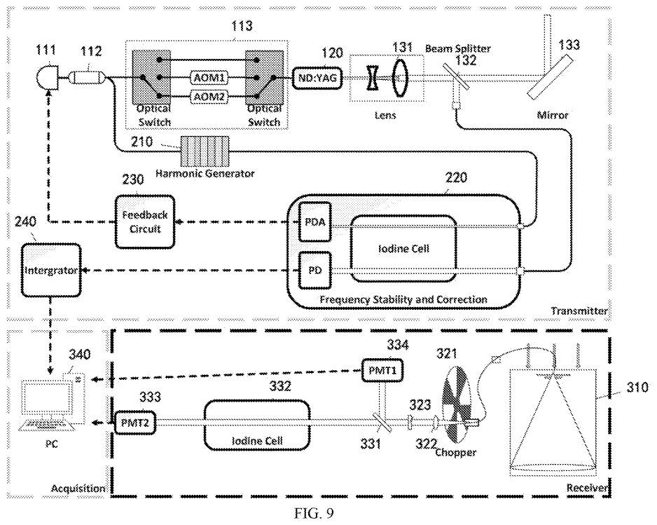

FIG. 8 shows a frame diagram of an iodine molecule processing device according to embodiments of the present disclosure.

According to embodiments of the present disclosure, the iodine molecule processing device includes: a second optical splitter 331 used to split the quasi-parallel beam into a first optical signal and a second optical signal; a first photomultiplier tube 334 used to perform a photoelectric conversion processing on the first optical signal to obtain a first electrical pulse signal, where the first electrical pulse signal indicates the reference signal; a second iodine cell 332 used to perform an absorption processing on the second optical signal to obtain a target echo signal; and a second photomultiplier tube 333 used to perform a photoelectric conversion processing on the target echo signal to obtain a target signal.

According to embodiments of the present disclosure, the second optical splitter 331 is used to split the echo signal into two paths. One path is a reflected light, and the ratio is 1%, and the other path is a transmitted light, and the ratio is 99%, where one path is used as a reference echo, that is, the first optical signal, which is used to eliminate the jitter of the echo signal itself; and the other path is the second optical signal, which is used as a main detection echo signal. A ratio of reflection and transmission may be specifically set as desired in practice.

According to embodiments of the present disclosure, the first photomultiplier tube 334 is used to convert the first optical signal into the first electrical pulse signal. This path is used as a reference signal to normalize the influence of the jitter of signal power.

According to embodiments of the present disclosure, the second iodine cell 332 transmits an atmospheric echo signal of three-frequency lasers (v₅₃₂, vs₃₂+2f₁ and v₅₃₂−2f₂) through the same optical path in a time-sharing manner, and performs an absorption processing on the second optical signal to obtain the target echo signal. An absorption strength is related to a frequency of the echo signal. The absorption strength for three-frequency signals may play a role of discriminating frequency shift information caused by the wind speed contained in the main detection echo signal.

According to embodiments of the present disclosure, the second photomultiplier tube 333 is used to detect three-frequency echo signals with the Doppler frequency shift caused by the movement of atmospheric molecules with wind speed after being absorbed by the iodine molecule absorption cell, and convert the three-frequency echo signals into the target signal.

FIG. 9 shows a structural flowchart of a Rayleigh Doppler lidar for measuring temperature and wind according to embodiments of the present disclosure.

In a specific embodiment, as shown in FIG. 9, the seed laser 111 outputs a continuous laser with a narrow band linewidth, the optical fiber beam splitter 112 splits the continuous laser into a first laser and a second laser, and the first laser is input into the optical fiber acousto-optic frequency shifter 113 to generate a first seed laser and a second seed laser each including sub-seed laser sequences with three different frequencies in time sequence; and the second laser used as the second seed laser is input into the harmonic generator to obtain a seed frequency-doubled laser, which is input to the frequency calibrator 220. The first pulse laser including sub-pulse laser sequences with three different frequencies is output after inputting the first seed laser into the pulse laser 120. A third laser is obtained by the beam expander 131 according to the first pulse laser. The third laser is split into a transmitting laser and a second pulse laser by the first optical splitter 132. The transmitting laser is transmitted to the atmospheric environment by a transmitting antenna 133, and the second pulse laser is input to the frequency calibrator 220. The seed frequency-doubled laser and the second pulse laser pass through the frequency calibrator 220 to obtain a first electrical signal. The control voltage signal is generated by the feedback circuit 230 according to the first electrical signal, and the control voltage signal is output to the wavelength adjustment module of the seed laser 111, so as to track and lock the seed laser frequency. The seed frequency-doubled laser passes through the frequency calibrator 220 to obtain a second electrical signal. The voltage level signal is generated by the integrator 240 according to the second electrical signal.

The telescope 310 receives the backscattered echo signal from the atmospheric environment and inputs it to the chopper 321. The chopper 321 suppresses the near-field strong echo signal in the backscattered echo signal to obtain a synchronous main signal. The synchronous main signal passes through the collimation lens 322 to obtain a quasi-parallel beam, which is filtered by the filter 323. The filtered quasi-parallel beam is split into a first optical signal and a second optical signal by the second optical splitter 331, where the first optical signal is processed by the first photon multiplier tube 334 to obtain a first electric pulse signal, that is, the reference signal; and the second optical signal is processed by the second iodine cell 332 to obtain a target echo signal, which is then processed by the second photomultiplier tube 333 to obtain a target signal.

The wind speed and/or the temperature in the atmospheric environment are measured by the computing processor 340 according to the reference signal, the target signal, and the voltage level signal mentioned above.

According to embodiments of the present disclosure, the seed laser generation device is used to generate the first seed laser and the second seed laser each including sub-seed laser sequences with three different frequencies in time sequence, the pulse laser is used to generate the first pulse laser including sub-pulse laser sequences with three different frequencies in a case that the first seed laser is injected in a time-sharing manner, the first pulse laser is input into the laser transmission coupling unit to generate the transmitting laser transmitted to the atmospheric environment and the second pulse laser, and at the same time, and the frequency calibration device outputs the control voltage signal and the voltage level signal based on the second seed laser and the second pulse laser, so as to control the seed laser generation device, so that the laser receiver receives the backscattered echo signal and the voltage level signal from the atmospheric environment while measuring the wind speed and the temperature in the atmospheric environment. Since the Rayleigh Doppler lidar for measuring temperature and wind of the present disclosure no longer depends on a density reference point and a temperature reference point, instead uses the first seed laser including the sub-seed laser sequences with three different frequencies in time sequence as a system laser source to achieve an absolute measurement of the temperature and the wind speed, it may avoid a temperature measurement error caused by the depending on the temperature reference point and the density reference point and a single-frequency laser wind measurement error caused by a temperature error, thereby greatly improving an accuracy and a sensitivity of the Rayleigh Doppler lidar for measuring temperature and wind when measuring the temperature and the wind speed.

Embodiments of the present disclosure have been described above. However, these embodiments are only for illustrative purposes and are not intended to limit the scope of the present disclosure. Although the various embodiments have been described above respectively, this does not mean that measures in the various embodiments may not be used in combination advantageously. The scope of the present disclosure is defined by the appended claims and their equivalents. Those skilled in the art may make three substitutions and modifications without departing from the scope of the present disclosure, and these substitutions and modifications shall all fall within the scope of the present disclosure.

1. A Rayleigh Doppler lidar for measuring temperature and wind, comprising:
a laser transmitter, comprising:
a seed laser generation device configured to generate a first seed laser and a second seed laser under a control of a control voltage signal, wherein each of the first seed laser and the second seed laser comprises sub-seed laser sequences with three different frequencies in time sequence;
a pulse laser configured to output a first pulse laser in a case that the first seed laser is injected into the pulse laser, wherein the first pulse laser comprises sub-pulse laser sequences with three different frequencies; and
a laser transmission coupling unit configured to generate a transmitting laser transmitted to an atmospheric environment and a second pulse laser according to the first pulse laser, wherein the transmitting laser interacts with a molecule in the atmospheric environment to generate a backscattered echo signal;
a frequency calibration device configured to output the control voltage signal and a voltage level signal according to the second seed laser and the second pulse laser, wherein the control voltage signal is configured to lock a laser frequency of the first seed laser; and
a laser receiver configured to receive the backscattered echo signal and simultaneously measure a wind speed and a temperature in the atmospheric environment according to the backscattered echo signal and the voltage level signal.

2. The lidar according to claim 1, wherein the seed laser generation device comprises:
a seed laser configured to output a continuous laser with a narrow band linewidth under the control of the control voltage signal;
an optical fiber beam splitter configured to split the continuous laser into a first laser and a second laser, wherein a power of the first laser is greater than a power of the second laser, and the second laser indicates the second seed laser; and
an optical fiber acousto-optic frequency shifter configured to generate the first seed laser according to the first laser.

3. The lidar according to claim 1, wherein the laser transmission coupling unit comprises:
a beam expander configured to adjust a laser spot and a divergence angle of the first pulse laser to obtain a third laser; and
a first optical splitter configured to split the third laser into the transmitting laser and the second pulse laser.

4. The lidar according to claim 3, wherein the laser transmission coupling unit further comprises:
a transmitting antenna configured to transmit the transmitting laser to the atmospheric environment.

5. The lidar according to claim 1, wherein the frequency calibration device comprises:
a harmonic generator configured to perform a frequency doubling processing on the second seed laser to obtain a seed frequency-doubled laser;
a frequency calibrator configured to generate a first electrical signal and a second electrical signal according to the second pulse laser and the seed frequency-doubled laser;
a feedback circuit configured to generate the control voltage signal according to the first electrical signal; and
an integrator configured to generate the voltage level signal according to the second electrical signal.

6. The lidar according to claim 5, wherein the frequency calibrator comprises:
a first iodine cell configured to:
process the seed frequency-doubled laser using an absorption spectrum of an iodine molecule, so as to obtain a processed seed frequency-doubled laser; and
process the second pulse laser using the absorption spectrum of the iodine molecule, so as to obtain a processed second pulse laser;
a first photodiode configured to perform an amplification and a photoelectric conversion processing on the processed seed frequency-doubled laser to obtain the first electrical signal; and
a second photodiode configured to perform a photoelectric conversion processing on the processed second pulse laser to obtain the second electrical signal;
wherein the voltage level signal is configured to monitor a frequency difference between the first pulse laser and the first seed laser to correct a detection error.

7. The lidar according to claim 1, wherein the laser receiver comprises:
a telescope configured to receive the backscattered echo signal returned from the atmospheric environment;
a signal processing device configured to generate a quasi-parallel beam according to the backscattered echo signal;
an iodine molecule processing device configured to generate a reference signal and a target signal according to the quasi-parallel beam; and
a computing processor configured to simultaneously measure the wind speed and the temperature in the atmospheric environment according to the reference signal, the target signal, and the voltage level signal.

8. The lidar according to claim 7, wherein the signal processing device comprises:
a chopper configured to suppress a near-field strong echo signal in the backscattered echo signal under a driving of a motor to obtain a synchronous main signal; and
a collimation lens configured to collimate the synchronous main signal to the quasi-parallel beam.

9. The lidar according to claim 8, wherein the signal processing device further comprises:
a filter configured to perform a filtering processing on a background optical signal in the quasi-parallel beam to obtain a filtered quasi-parallel beam, so as to process the filtered quasi-parallel beam by the iodine molecule processing device.

10. The lidar according to claim 7, wherein the iodine molecule processing device comprises:
a second optical splitter configured to split the quasi-parallel beam into a first optical signal and a second optical signal;
a first photomultiplier tube configured to perform a photoelectric conversion processing on the first optical signal to obtain a first electrical pulse signal, wherein the first electrical pulse signal indicates the reference signal;
a second iodine cell configured to perform an absorption processing on the second optical signal to obtain a target echo signal; and
a second photomultiplier tube configured to perform a photoelectric conversion processing on the target echo signal to obtain the target signal.
